(19) United States
(12) Patent Application Publication
(10) Pub. No.: US 2012/0254936 A1
(43) Pub. Date: Oct. 4, 2012

(54) APPARATUS AND METHOD FOR SECURITY AND NETWORK MANAGEMENT BASED ON FLOW

(75) Inventors: Dong-Myoung BAEK, Daejeon-si (KR); Bhum-Cheol LEE, Daejeon-si (KR); Seung-Woo LEE, Daejeon-si (KR); Sang-Yoon OH, Daejeon-si (KR); Kang-Il CHOI, Daejeon-si (KR); Young-Ho PARK, Daejeon-si (KR)

(73) Assignee: Electronics and Telecommunications Research Institute, Daejeon-si (KR)

(21) Appl. No.: 13/433,859

(22) Filed: Mar. 29, 2012

(30) Foreign Application Priority Data
Apr. 1, 2011 (KR) 10-2011-0030331

(51) Int. Cl. G06F 21/00

(52) U.S. Cl. 726/1

(57) ABSTRACT

There are provided an apparatus and method for security and network management based on flows. The flow-based security and network management apparatus generates data flows from network packets, and performs network management in connection with security management based on the generated data flows. Accordingly, it is possible to maximally guarantee traffic fairness between users against attack or intrusion traffic.

### CROSS-REFERENCE TO RELATED APPLICATION

This application claims the benefit under 35 U.S.C. §119(a) of a Korean Patent Application No. 10-2011-0030331, filed on Apr. 1, 2011, the entire disclosure of which is incorporated herein by reference for all purposes.

### BACKGROUND

1. Field

The following description relates to network technology, and more particularly, to a technique for security and network management based on flow.

2. Description of the Related Art

With the spreading of the Ethernet, terminals are being aggregated with servers and such aggregation is conducted generally through Ethernet switches. The Ethernet switches are effective in aggregating a few terminals with a server, however, not suitable for aggregating a great number of terminals with one or more servers since fairness is not sufficiently guaranteed due to multi-stage connections. Nevertheless, since no alternative plan for aggregating Ethernet-based terminals with a server has been proposed so far, Ethernet switches have continued to be used for aggregation.

In order to ensure network safety, security management against network traffic is essential. In general, security management is performed by a high performance processor since requiring analysis of characters, strings, data structures, etc. Accordingly, such security management is performed especially in Layer 7 rather than in Layer 2 through Layer 4 after traffic is collected in the network layer.

General topology for security management and aggregation against packet traffic is to perform security management through a Layer-7 processor after performing aggregation through an Ethernet switch. In network topology, aggregation is performed in a layer (generally, Layer 2) lower than the network layer, and security management is performed in Layer 4 through Layer 7 that are the upper layers.

A method of performing security management after aggregation may result in performing security management after the traffic fairness of other users is broken due to traffic congestion. Furthermore, the method is vulnerable to the counterfeits of end users' addresses or users' source/destination addresses.

### SUMMARY

The following description relates to a flow-based security and network management apparatus and method capable of maximally guaranteeing traffic fairness between users against attack or intrusion traffic.

In one general aspect, there is provided a flow-based security and network management apparatus including: a flow generator configured to generate a data flow from a network packet; a network manager configured to perform network management based on the data flow; and a security manager configured to determine fairness of the data flow, and to provide the network manager with a predetermined security policy for the network management according to the result of the fairness determination, wherein the security manager interworks with the network manager for the network management.

In another general aspect, there is provided a flow-based security and network management method including: generating a data flow from a network packet; and performing network management in connection with security management based on the data flow.

Therefore, by performing network management in connection with security management, it is possible to prevent traffic congestion upon aggregation. Also, since network and security management is processed in unit of a flow, it is efficient that security management can selectively performed in unit of a flow. Furthermore, Layer 2 through Layer 7 may be processed by a single apparatus or a plurality of apparatuses. In addition, by efficiently blocking attack or intrusion flows, the traffic fairness of sound users can be maintained.

Other features and aspects will be apparent from the following detailed description, the drawings, and the claims.

### BRIEF DESCRIPTION OF THE DRAWINGS

FIG. 1 is a diagram illustrating an example of a flow-based security and network management apparatus.

FIG. 2 illustrates a detailed configuration diagram of the flow-based security and network management apparatus illustrated in FIG. 1.

FIG. 3 is a flowchart illustrating an example of a flow-based security and network management method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

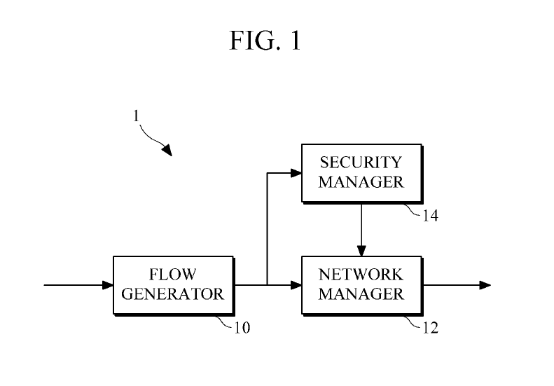

FIG. 1 is a diagram illustrating an example of a flow-based security and network management apparatus.

Referring to FIG. 1, the flow-based security and network management apparatus includes a flow generator 10, a network manager 12, and a security manager 14.

The flow generator 10 generates a data flow from a network packet. The network manager 12 interworks with the security manager 14. That is, the network manager 12 manages a network in connection with the security manager 12 based on the data flow generated by the flow generator 10. The network management by the network manager 12 may include at least one of bandwidth control, aggregation, forwarding, switching, and routing of the data flow. The security manager 14 determines the fairness of the data flow and provides the network manager 12 with a predetermined security policy for network management according to the result of the determination. The predetermined security policy includes a network management policy, such as a bandwidth management policy, a packet control policy, etc.

Hereinafter, the flow generator 10, the network manager 12, and the security manager 14 will be described in more detail.

The flow generator 10 receives a network packet and creates a data flow based on packet information included in the network packet. The packet information includes header information and payload information. If the flow generator 10 creates a data flow based on payload information, rule consistency may be maintained. At this time, it is important to maintain independency between data flows. Accordingly, according to an example, the flow generator 10 generates a data flow using packet header information.

The network manager 12 interworks with the security manager 14 to perform basic functions for network management according to a predetermined security policy that is provided for each data flow. The basic functions for network management include bandwidth control, aggregation, flow forwarding, switching, and routing. The network manager 12 may perform the basic functions for network management in unit of a data flow that is generated by the flow generator 10.

The security manager 14 determines the fairness of the data flow. At this time, the security manager 14 may determine the fairness of the data flow in unit of a flow according to a predetermined rule. Or, the security manager 14 may determine the fairness of the data flow based on the relevancy between data flows. The security manager 14 determines the fairness of the data flow, and provides the network manager 12 with a predetermined network management policy according to the result of the determination, in unit of a data flow.

If the security manager 14 determines the fairness of the data flow in unit of a data flow, the accuracy of the determination is closely associated with the number of predetermined rules, whereas if the security manager 14 determines the fairness of the data flow based on the relevancy between data flows, the accuracy of the determination is relatively irrelevant to the number of predetermined rules. For this reason, the security manager 14 determines the fairness of the data flow based on the relevancy between data flows. In this case, the frequent update of the predetermined rules is not needed.

Hereinafter, an operation process in an Internet Protocol (IP) packet network environment will be described.

The flow generator 10 receives a packet through one or more interfaces. Then, the flow generator 10 generates a hash key using the header and payload information of the received packet. However, it is difficult to regularly generate flows using the payload information of the packet since the payload information is dependent on traffic attributes. Accordingly, the flow generator 10 generates a hash key using the header information of the packet. The packet header information may include an IP address, TCP port information, etc. Successively, the flow generator 10 generates a hash value by applying the hash key to a predetermined hash function, and maps the hash value to a flow. Thereafter, the flow generator 10 selects packet header information, hash keys, and hash functions such that the types of flows generated in this way are independent from each other.

The flow generator 10 generates a sufficient number of flows such that the types of the generated flows are independent from each other. Since the types of flows are independent from each other, the different types of flows are operatable in different processor cores (multi-cores or multi-processors), except for the same type of successive flows.

The network manager 12 controls the bandwidths of the flows generated by the flow generator 10. The bandwidth control includes polishing, shaping, bandwidth-limiting, and flow control. Thereafter, the network manager 12 performs aggregation, transmission, switching, routing, etc. The network manager 12 controls the bandwidths of the flows based on bandwidth control or packet management policies that are provided in unit of a flow from the security manager 14. For example, if the security manager 14 has set a bandwidth-limiting policy for limiting the bandwidth of a specific flow or a packet discard policy for discarding a specific flow, the network manager 12 limits the bandwidth of the corresponding flow or discards the flow before aggregation, transmission, and switching.

The bandwidth-limiting by the network manager 12 may be performed in unit of a flow that is generated by the flow generator 10. Accordingly, the network manager 12 may selectively bandwidth-limit or discard only attack or intrusion flows. At this time, flows whose fairness has not been proven are bandwidth-limited or discarded continuously as long as no security policies provided by the security manager 14 are changed.

The network manager 12 limits the bandwidths of flows in unit of a flow, and collects, distributes, transmits, switches, and routes flows. The network manager 12 also may be implemented as a multi-core processor. In this case, by configuring a multi-core processor capable of processing flows in parallel, the network management performance may be improved.

The security manager 14 determines the fairness of a flow (that is, a packet) generated by the flow generator 10 by checking the type of the header or payload of the flow. Or, the security manager 14 determines the fairness of the flow by checking the header and/or payload of the flow according to the type of the flow to check the relevancy between flows. Then, the security manager 14 provides the network manager 12 with a predetermined network management policy, such as bandwidth-limiting, aggregation, etc., according to the result of the fairness determination, in unit of a flow. Since the security manager 14 transfers a predetermined network management policy to the network manager 12 in unit of a flow, the network manager 12 can filter only attack or intrusion flows, thereby protecting fair flows.

If the security manager 14 checks the characters, strings, data structures, etc. of the headers and/or payloads of flows (packets) generated by the flow generator 10 to determine the fairness of the flows, there are difficulties in security management since many rules have to be used and the rules are also changed.

In contrast, according to the current example, since the flow generator 10 generates different types of flows that are independent from each other, the same type of flows relevant to each other are determined to have high possibility that they are attack or intrusion flows. Accordingly, if the security manager 14 checks the relevancy between flows for each type of flow, security management is easy since a smaller number of rules can be used than in the case of checking relevancy in unit of a flow and also the rules are not changed.

According to an example, the security manager 14 determines the fairness of flows in association with the traffic status of the network manager 12 in order to more accurately determine the fairness of the flows. That is, the security manager 14 determines the fairness of flows that are expected to increase or congest traffic in consideration of the traffic status of the network manager 12, and provides the network manager 12 with a predetermined flow-based network management policy according to the result of the determination. Then, the network manager 12 manages the network according to the network management policy. As described above, since the security manager 12 checks the relevancy between flows for each type of flow or in unit of a flow and thereby the network manager 12 can focus on flows that are expected to increase or congest traffic, more efficient security management is possible.

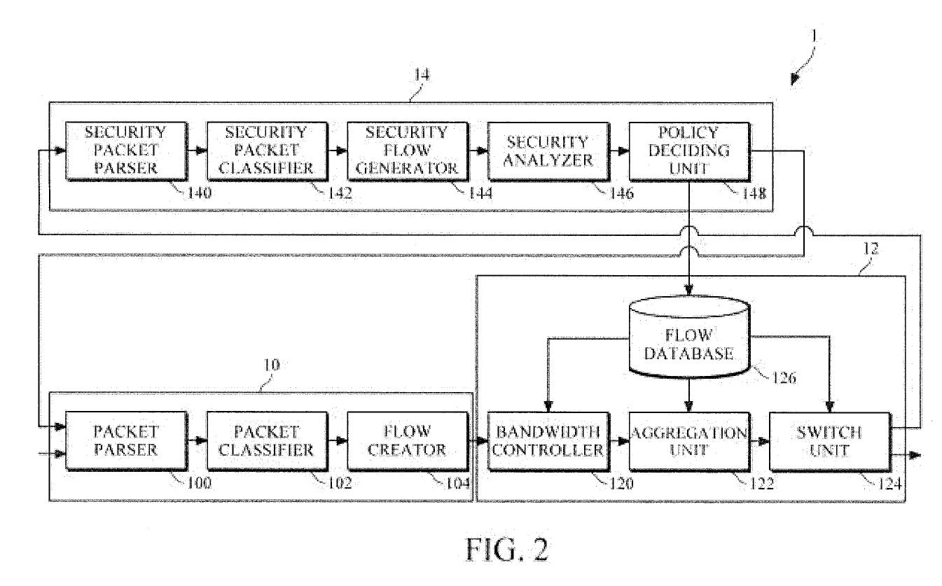

FIG. 2 illustrates a detailed configuration diagram of the flow-based security and network management apparatus 1 illustrated in FIG. 1.

Referring to FIGS. 1 and 2, the flow generator 10 includes a packet parser 100, a packet classifier 102, and a flow creator 104.

The packet parser 100 receives packets and parses the headers and/or payloads of the packets according to a predetermined rule. The packet classifier 102 classifies the packets according to a predetermined classification method. For the simpler calculation, the packet classifier 102 may create hash keys using information extracted by the packet parser 100.

After the packets are classified according to their types such that the types of the packets are independent from each other, the flow creator 104 maps the classified packets to flows. In order to simplify operation of creating flows based on packet classification, the flow creator 104 may create hash values by applying the hash keys to a hash function and map the hash values to flows. The flow creator 104 selects packet header information, hash keys, and hash functions such that the types of the created flows are independent from each other. The packet header information may include IP addresses, TCP port information, etc.

The network manager 12 includes a bandwidth controller 120, an aggregation unit 122, a switch unit 124, and a flow database 126.

The bandwidth controller 120 receives flows generated by the flow creator 104. The bandwidth controller 120 controls the bandwidths of the flows generated by the flow creator 104 in unit of a flow according to predetermined security policies received from the security manager 14. Successively, the aggregation unit 122 and the switch unit 124 perform network management functions, such as aggregation, transmission, switching, and routing, on the flows passed through the bandwidth controller 120, wherein the network management functions may be controlled according to the predetermined security policies received from the security manager 14.

The flow database 126 stores security policies including a bandwidth control policy or a packet discard policy, which are provided in unit of a packet from the security manager 14. The security policies are stored in the flow database 126 through a path connecting the security manager 14 to the network manager 12. That is, a policy deciding unit 148 of the security manager 14 is logically connected to the flow database 126 of the network manager 12.

The bandwidth controller 120 limits the bandwidths of the corresponding flows or discards the flows according to security policies stored in unit of a flow in the flow database 126. Accordingly, the flows may be bandwidth-limited or discarded before subject to aggregation, transmission, switching, and routing.

The bandwidth-limiting according to the security policies provided by the security manager 14 may be selectively performed. That is, flows irrelevant to the security policies provided by the security manager 14 are output to a network (or a server) via the aggregation unit 122 and the switch unit 124. Meanwhile, flows that have to be subject to bandwidth-limiting and/or aggregation, switching, and routing according to the security policies of the security manager 14 are output to the security manager 14 via the aggregation unit 122 and the switch unit 124.

The security manager 14 includes a security packet parser 140, a security packet classifier 142, a security flow generator 144, a security analyzer 146, and the policy deciding unit 148.

The security packet parser 140, the security packet classifier 142, and the security flow generator 144 receive flows output from the network manager 12 and generate flows each having the same format as or a different format from that generated by the flow generator 10. Here, the flows are generated in correspondence to flows generated by the flow generator 10, using packet information that has been used in the flow generator 10 to generate the flows, although the flows have a different format from that generated by the flow generator 10.

The security analyzer 146 determines the fairness of the flows generated by the security flow generator 144, in unit of a flow. At this time, the flows may not be the same as those generated by the flow generator 10, but they are in correspondence to those generated by the flow generator 10 although the flows are different from those generated by the flow generator 10. The security analyzer 146 determines the types of the flows to check security, or determines the relevancy between the flows for each kind of flow to check security.

The policy deciding unit 148 decides network security policies of the flows according to the result of the fairness determination by the security analyzer 146. The network security policies may be decided in unit of a flow. If the flows that are processed by the security analyzer 146 are different from those generated by the flow generator 10, the policy deciding unit 148 may decide network security polices in unit of a flow using the correspondence relationship between the flows and those generated by the flow generator 10.

If the policy deciding unit 148 decides security policies in unit of a flow and output them to the flow generator 10, the security policies are input to the network manager 12 via the flow generator 10 and stored in the flow database 126. Accordingly, packets input to the flow generator 10 are transferred to the security manager 14 via the network manager 12, and the security policies decided by the security manager 14 are reflected to the network manager 12. As a result, the network manager 12 interworks with the security manager 14 to thereby simultaneously perform network management and security management.

Entire processing from layer 2 to layer 7 is required to simultaneously perform network management and security management, and there are difficulties in processing such entire processing in a single apparatus. However, according to the examples as described above, by interworking the network manager 12 with the security manager 14, network and security management can be efficiently carried out.

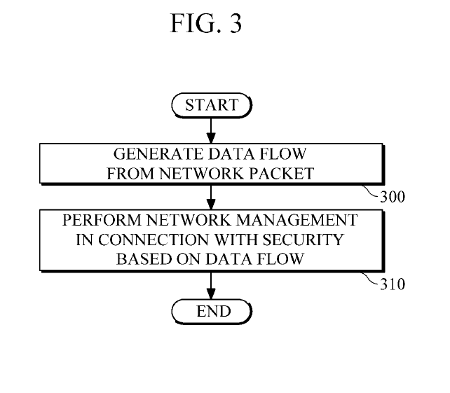

FIG. 3 is a flowchart illustrating an example of a flow-based security and network management method.

Referring to FIGS. 1 and 3, the security and network management apparatus 10 generates data flows from network packets (300). According to an example, the security and network management apparatus 10 receives and parses packets. Then, the security and network management apparatus 10 generates hash keys using information extracted by parsing the packets and generates hash values by applying the hash keys to a hash function to thereby classify the packets. Then, the security and network management apparatus 10 maps the classified packets to flows.

Successively, the security and network management apparatus 1 performs network and security management on the flows (310). The network management includes at least one of bandwidth-limiting, aggregation, flow transmission, switching, and routing of the flows.

According to an example, in operation 310, the security and network management apparatus 1 determines the fairness of the flows. Then, the security and network management apparatus 1 reflects a network management policy for each flow, according to the result of the fairness determination, to manage a network. At this time, the security and network management apparatus 1 controls the bandwidth of each flow according to the corresponding network management policy. For example, the security and network management apparatus 1 collects flows whose bandwidths have been controlled and performs flow transmission, switching, and routing on the collected flows.

According to an example, in operation 310, the security and network management apparatus 1 manages a network for each flow. Also, the security and network management apparatus 1 determines the fairness of flows output according to the result of the network management. Successively, the security and network management apparatus 1 reflects a network management policy for each flow according to the result of the fairness determination upon network management.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A flow-based security and network management apparatus comprising:
a flow generator configured to generate a data flow from a network packet;
a network manager configured to perform network management based on the data flow; and
a security manager configured to determine fairness of the data flow, and to provide the network manager with a predetermined security policy for the network management according to the result of the fairness determination, wherein the security manager interworks with the network manager for the network management.

2. The flow-based security and network management apparatus of claim 1, wherein the network management includes at least one of bandwidth-limiting, aggregation, flow transmission, switching, and routing of the data flow.

3. The flow-based security and network management apparatus of claim 1, wherein the security manager provides the network manager with a predetermined security policy for each flow, according to the result of the fairness determination, and the network manager reflects the predetermined security policy to perform the network management, so that the network management is performed in connection with security management.

4. The flow-based security and network management apparatus of claim 3, wherein the security manager determines fairness of a flow that is expected to increase or congest traffic in consideration of a traffic status of the network manager, and provides the network manager with a predetermined security policy for each flow, according to the result of the fairness determination.

5. The flow-based security and network management apparatus of claim 1, wherein the network manager provides the security manager with a flow output according to the result of the network management, and the security manager determines fairness of the flow provided from the network manager to provide the network manager with a predetermined security policy for each flow, according to the result of the fairness determination, so that the network management is performed in connection with security management.

6. The flow-based security and network management apparatus of claim 1, wherein the network manager performs the network management for each flow, and the security manager performs the security management for each flow.

7. The flow-based security and network management apparatus of claim 1, wherein the flow generator comprising:
a packet parser configured to receive a packet and parse the received packet;
a packet classifier configured to create a hash key using information extracted by parsing the packet, to create a hash value by applying the hash key to a hash function, and to classify the packet according to the hash value; and
a flow creator configured to map the classified packet to the data flow.

8. The flow-based security and network management apparatus of claim 7, wherein the flow generator parses a header of the received packet.

9. The flow-based security and network management apparatus of claim 1, wherein the network manager comprises:
a bandwidth controller configured to control a bandwidth of the flow in unit of a flow according to the predetermined security policy received from the security manager;
an aggregation unit configured to collect flows whose bandwidth have been controlled; and
a switch unit configured to perform flow transmission, switching, and routing on the collected flows.

10. The flow-based security and network management apparatus of claim 9, wherein the bandwidth controller limits a bandwidth of a predetermined data flow or discards/allows a predetermined packet, based on the predetermined security policy received from the security manager, wherein the predetermined security policy includes a bandwidth control policy or a packet control policy.

11. The flow-based security and network management apparatus of claim 1, wherein the security manager checks fairness of the flow in unit of a flow according to a predetermined rule.

12. The flow-based security and network management apparatus of claim 1, wherein the security manager checks relevancy between data flows for each type of data flow to determine the fairness of the data flow.

13. The flow-based security and network management apparatus of claim 1, wherein the security manager comprises:
a security analyzer configured to determine the fairness of the data flow; and
a policy deciding unit configured to decide a security policy of the data flow according to the result of the fairness determination.

14. The flow-based security and network management apparatus of claim 13, wherein the flow whose fairness has been proven by the security manager is the same as a flow generated by the flow generator, or the flow whose fairness has been proven by the security manager is in correspondence to the flow generated by the flow generator if the flow whose fairness has been proven by the security manager is different from the flow generated by the flow generator.

15. A flow-based security and network management method comprising:
generating a data flow from a network packet; and
is performing network management in connection with security management based on the data flow.

16. The flow-based security and network management method of claim 15, wherein the performing of the network management in connection with the security management comprises:
determining fairness of the data flow; and
reflecting a predetermined security policy for each flow, according to the result of the fairness determination, to the network management.

17. The flow-based security and network management method of claim 16, wherein the reflecting of the predetermined security policy for each flow comprises:
controlling a bandwidth of the data flow according to the predetermined security policy;
collecting data flows whose bandwidths have been controlled; and
performing flow transmission, switching, and routing on the collected data flows.

18. The flow-based security and network management method of claim 15, wherein the performing of the network management in connection with the security management comprises:
performing the network management for each data flow;
determining fairness of a data flow output according to the result of the network management; and
reflecting the predetermined security policy for each data flow, according to the result of the fairness determination, to the network management.
